(19) United States
(12) Patent Application Publication
(10) Pub. No.: US 2026/0279869 A1
(43) Pub. Date: Sep. 17, 2026

(54) ADDITIVES FOR REDOX MEDIATED FLOW BATTERIES

(71) Applicant: Schlumberger Technology Corporation, Sugar Land, TX (US)

(72) Inventor: Debora Campos de Faria, Cambridge (GB)

(21) Appl. No.: 19/561,604

(22) Filed: Mar. 10, 2026

(30) Foreign Application Priority Data
Mar. 12, 2025 (GB) 2503667.4

(51) Int. Cl. H01M 8/18; H01M 8/0258; H01M 8/04082; H01M 8/08

(52) U.S. Cl. CPC H01M 8/188; H01M 8/0258; H01M 8/04201; H01M 8/08

(57) ABSTRACT

In a redox mediated battery system having a half-cell connected to a vessel containing an insoluble solid substance which is present as a bed of granules or other porous mass and which is converted between first and second states during charge and discharge, the electrolyte liquid includes a solute capable of causing elastic turbulence in the liquid, while the flow paths for electrolyte liquid through the porous mass of insoluble solid substance are configured to compel changes in direction of flow thereby inducing elastic turbulence in contact with the insoluble solid substance. Elastic turbulence may also be induced in the half-cell.

### CROSS REFERENCE TO RELATED APPLICATIONS

This application claims priority to GB Patent Application No.: 2503667.4, which was filed on Mar. 12, 2025, and is incorporated herein by reference in its entirety.

### FIELD

This disclosure relates to redox mediated flow batteries used for the chemical storage of electrical energy.

### BACKGROUND

Redox flow batteries are used to store electrical energy by means of a reversible electrochemical process. A flow battery normally consists of two half-cells at either side of a membrane which separates the electrolyte liquids of the two half-cells but allows passage of ions which are required to cross from one half-cell to the other. During charge and discharge, in each half-cell, an electrolyte liquid containing a chemical species which undergoes electrochemical reaction is pumped through the half-cell from an associated storage vessel and after passing through the half-cell, is either made to flow onwards to another storage vessel or circulated back to the vessel it came from. Flow batteries have the advantage that the storage capacity for electrical energy is not determined by the size of the electrochemical cell but by the volume of electrolyte liquid which is held in the storage vessels.

Since the energy is stored by chemical compounds in solution whose concentration is limited by their solubility the storage vessels may need to be large. A development, termed a “redox mediated flow battery” or a “redox targeted flow battery” improves the energy density by means of a further chemical step involving solid material which stores energy. The soluble reactive species which has been changed electrochemically in the half-cell is used to bring about a reversible change to another reactive species which is a solid and is insoluble in the electrolyte liquid. In doing so, the soluble reactive species is returned to its original state. This has the consequence that the energy is stored by material which is a solid and in consequence the energy stored in a given volume can be significantly increased. The solid material may be held in the storage vessel and is sometimes referred to as a “solid booster”.

This approach can be implemented in two ways. One possibility uses two soluble reactive species in the electrolyte liquid. During charge, a first reactive species which is in solution is converted to a different state by electrochemical reaction at an electrode and then reacts with the solid material, changing that solid material to a different state and itself being returned to its original state. During discharge, a second reactive species in solution reacts with the solid material and then undergoes electrochemical reaction in the half-cell. The first and second reactive species are chosen so as to have redox potentials with magnitudes which are slightly above and slightly below the redox potential of the solid material, for instance, not more than 100 mV above and below the redox potential of the solid material. The other possibility is to use a single soluble reactive species chosen to have a redox potential which closely matches the redox potential of the solid material. The reversible reaction between the soluble reactive species and the solid material is driven by concentrations present during charge and discharge. A detailed description of this process in which reversible reactions are driven by concentrations which are themselves driven by the electrical charging and discharging is provided by Moghaddam et. al., “Thermodynamics, Charge Transfer and Practical Considerations of Solid Boosters in Redox Flow Batteries”, Molecules 2021, Vol 26, 2111.

A redox mediated flow battery may have two electrochemical half-cells, each of which is connected to a respective vessel containing a solid reactive species. It is also possible that one half-cell is connected to a vessel containing a solid reactive species but the other half-cell functions in another way. Possibilities for this other half-cell include a regenerative fuel cell producing gas during charging and consuming the gas as fuel while electricity is being discharged, a half-cell where a solid is deposited at an electrode during charge or discharge and even a conventional flow battery half-cell.

In these various possibilities, a flowing electrochemical cell is an electrochemical reactor in which an electrolyte liquid containing reactive chemical species is made to flow past or through an electrode. At the electrode, an electrochemical reaction occurs due to an externally applied potential that results in the transfer of one or more electrons from the electrode to the electroactive chemical species, or vice versa. For this process to occur, the electroactive species in solution moves to the electrode surface, associates with the surface in such a way as to enable the transfer of electrons and subsequently moves away from the surface. Consequently, the amount of electric current at the electrode is dependent on the amount of the electroactive chemical species at the electrode surface. For these reasons, it is desirable to have an electrode of high surface area and also have rapid mass transport, that is to say rapid transport of reactive species and reacted species to and from this electrode surface.

A porous material can provide a high surface area, and a considerable body of work exists in the creation of structured carbon electrodes for flowing electrochemical cells. Commonly applied high-surface area materials include felts, cloths and papers of polymer (synthetic and natural) fibers. These structures are variously woven, precipitated from solution, electro-spun or otherwise made into a porous matrix with a high surface area, before being converted primarily to carbon through “carbonization” in which the majority of non-carbon elements present in an organic material (e.g. H, O and N) are removed, typically at high temperatures under a non-reactive atmosphere. Designs which use a high surface area porous material can be classified as either “flow through” type in which there is an inlet to the porous material in one place and an outlet from it in another place or “flow-past” type in which the fluid flows across an outer surface of a body of porous material (which may be a thin body) and at least some of the fluid flow diffuses into the porous matrix. A flow-past design may have the advantage of a relatively low resistance to flow, with a largely even distribution of fluid when it is delivered to the porous electrode. However, this comes at the cost of relying on diffusive transport in the direction perpendicular to the channel and within the porous electrode to facilitate the movement of electroactive species from the channel, to and from the electrode. Electrodes which are entirely flow-through, or flow-past represent extremes. There are many flow field designs which are in between.

A porous material can maximize the rate at which reactions can occur for a given geometrical electrode area (i.e. the area within an outline of the electrode). However, as the surface area of an electrode is increased for a constant geometrical area, the permeability of the electrode typically decreases, causing a higher pressure-drop across the electrode and requiring more energy to be consumed for electrolyte liquid circulation. There has to be a compromise between the conflicting requirements of high surface area and low pressure drop as the electrolyte liquid flows over or through the electrode.

### SUMMARY

This summary is provided to introduce concepts that will be further elaborated and described below in the detailed description. This summary is not intended to identify key or essential features of the claimed subject matter, nor is it intended to be used as an aid in limiting the scope of the claimed subject matter.

This disclosure uses the phenomenon of elastic turbulence which was discovered during the latter part of the twentieth century. It occurs at a flow rate where a Newtonian liquid such as pure water would be in a state of laminar flow.

In a first aspect, this disclosure relates to an electrochemical system for a battery, the system comprising an electrochemical half-cell having an electrode, an electrolyte liquid containing a first reactive substance dissolved therein which is able to undergo an electrochemical reaction at the electrode, and structure defining a flow path to carry flow of the liquid into contact with the electrode; a vessel containing a porous mass comprising a reactive substance which is a solid and is insoluble in the liquid, with the vessel and the porous mass defining a flow path to carry flow of the liquid through the porous mass, at least one pump, and piping connecting the pump, the vessel and the half-cell for the pump to circulate the liquid from the vessel to the half-cell, through the half-cell and back to the vessel, wherein the dissolved and insoluble reactive substances are such that when electric current is supplied to charge the battery system while the pump is circulating the liquid, the first dissolved reactive substance is converted at the electrode to a second dissolved reactive substance which subsequently reacts in the vessel with the insoluble solid reactive substance in a reaction where the insoluble solid reactive substance is converted from a first state to a second state and the second dissolved reactive substance is converted back to the first dissolved reactive substance, and during discharge of electric current from the battery system while the pump is circulating the liquid, the insoluble solid reactive substance undergoes reaction with a reactive substance dissolved in the liquid, in which reaction the insoluble solid reactive substance reverts from its second state to its first state and the dissolved reactive substance is converted to another dissolved reactive substance and subsequently that conversion is reversed by electrochemical reaction at the electrode; and further wherein: the liquid also contains a solute enabling the liquid to display elastic turbulence, and the flow path through the porous mass in the vessel is configured to compel changes in the direction of liquid flow, to cause elastic turbulence of the liquid in contact with the solid reactive substance in the porous mass within the vessel.

The porous mass may include the liquid-insoluble solid reactive substance, or it may include an inert support carrying the liquid-insoluble solid reactive substance. The porous mass may be a bed of the insoluble solid material in granular form, for example, as particles with a mean diameter in a range from 0.5 mm to 2 cm. Another possibility is that the porous mass is in the form of one or more porous blocks formed of or containing the insoluble solid material.

The dissolved reactive substance which participates in reaction with the insoluble solid during discharge may be the first reactive substance which participated in reaction during charging, or it may be a different reactive substance, also dissolved in the electrolyte liquid.

A further possibility is that the flow path in contact with the electrode in a half-cell is also configured to compel changes in the direction of fluid flow, so as to cause elastic turbulence within flow of the liquid in contact with the electrode, so that there is elastic turbulence both in the vessel and in the half-cell.

A flow path configured to enable elastic turbulence in contact with an electrode may be provided by a porous material located adjacent to the electrode, where the flow paths through the material repeatedly change direction. Alternatively, a flow path in contact with an electrode may contain obstructions which compel the fluid flow to make a succession of changes of direction. In embodiments, a flow guide adjacent to an electrode provides an array of spaced obstructions which compel changes in flow direction.

In the half-cell, elastic turbulence enhances mass transport, that is to say it improves the transport of dissolved reactive species to the surface of an electrode and also the transport of dissolved reaction product away from the electrode surface more rapidly than by diffusion through the liquid. If a porous electrode has a flow-by design, elastic turbulence in a channel adjoining a porous electrode will increase the pressure drop along the channel and this will cause more fluid to enter the porous electrode.

In the vessel with porous packing of insoluble solid, elastic turbulence enhances mass transport to and from the insoluble solid present as a porous packing. This increases the concentration of soluble reactive substance arriving at the immediate vicinity of the solid surface and likewise the transport of reaction product from that vicinity. Consequently, the rates of reaction converting one substance to another are increased.

A consequence of good rates of reaction in the vessel is that the amount of second reactive substance which fails to react in the vessel and is circulated back to the half-cell is kept low. Unreacted second reactive substance returning to the half-cell would otherwise be a cause of overpotential in that half-cell.

An advantage of elastic turbulence is that it occurs at flow rates where flow of a Newtonian fluid such as pure water would be laminar and so it is not necessary to pump the fluid at a high flow rate to achieve flow velocities where inertial turbulence would occur. Consequently, the required pumping power and the amount of electrical power consumed by pumping can be significantly lower than would be required for a system where elastic turbulence did not occur.

This disclosure also provides a method of operating a system as above, where the method comprises pumping the fluid in a condition of elastic turbulence while it is in contact with the electrode and in a condition of elastic turbulence while it is in contact with the granular solid material in the vessel.

The electrolyte liquid used in a system as above may be aqueous or a non-aqueous polar liquid. If aqueous the liquid may be a solution with water as the only solvent or it may contain a mixture of water and a water-soluble organic solvent.

A flow battery may contain two systems as above, with the half-cells at either side of a separator which may be an ion exchange membrane. Another possibility is that an electrochemical system as above could be combined with a half-cell of a different type of electrochemical system.

### BRIEF DESCRIPTION OF THE DRAWINGS

Many of the drawings are diagrammatic and are intended to show the positions of component parts in relation to each other. Thin components such as membranes are shown with exaggerated thickness to make them and their positions more readily seen in these drawings.

FIG. 1 is a plot of experimental results showing onset of elastic turbulence.

FIG. 2 is a perspective view of a flow guide.

FIG. 3 is an enlarged top view of a portion of the flow guide.

FIG. 4 is a diagram of apparatus for observing elastic turbulence by means of birefringence.

FIG. 5 shows, in greyscale, pictures obtained with the apparatus of FIG. 4.

FIG. 6 is a schematic cross-sectional view of a redox mediated flow battery

FIG. 7 shows an alternative packing for vessels of the flow battery of FIG. 6.

FIG. 8 is a schematic view generally similar to FIG. 6 with provision for elastic turbulence in the half-cells.

FIG. 9 shows a different possibility for the electrochemical cell of FIG. 8.

FIG. 10 is an enlarged top view of a portion of another flow guide.

FIG. 11 is a schematic cross-sectional view of a hybrid electrochemical system.

FIG. 12 shows a system with three of the electrochemical cells of FIG. 8 connected as a stack.

FIG. 13 is a diagrammatic view of apparatus to determine operating parameters for an electrochemical half-cell.

FIGS. 14 and 15 show experimental results obtained with an example of the apparatus of FIG. 13.

### DETAILED DESCRIPTION

This detailed description shows various embodiments of the present disclosure and possibilities which may be used. It should be appreciated that features or possibilities described in combination may, where it is practical to do so, be used separately. Also, features or possibilities described in any embodiment may be used in any other embodiment, in so far as it is possible to do so.

The present disclosure uses the phenomenon of elastic turbulence. It is of course well known that Newtonian liquids such as pure water can undergo either laminar flow or turbulent flow. Such turbulent flow may be referred to as inertial turbulence. Conditions for laminar flow and inertial turbulent flow are often expressed by Reynolds number which is a ratio of inertial to viscous forces within a liquid. Reynolds number has no dimensions because it is a ratio. At Reynolds number above about 2000 there is inertial turbulent flow. At Reynolds number below about 1500, flow of a Newtonian liquid is laminar. Flow paths within porous materials often have small dimensions and rapid flow rates through such materials are not achievable with the consequence that it is not a practical possibility for flows through porous materials to undergo inertial turbulence.

Elastic turbulence is different from inertial turbulence. It is a physical phenomenon discovered during the latter part of the twentieth century. It has been observed at low flow speeds where Reynolds number is low, and a Newtonian liquid would be in a state of laminar flow. Some early observations of elastic turbulence used the older term “elastic instability”. However, that term is more general and includes other forms of instability in flow. Literature documents relating to elastic turbulence include a detailed discussion by Steinberg, V. (2021), “Elastic Turbulence: An Experimental View on Inertialess Random Flow”, Annual Review of Fluid Mechanics, 53, 27-58.

The phenomenon of elastic turbulence of a liquid requires: a solute which has elastic properties, enabling the liquid solution to display elastic turbulence; a flow path for the liquid which compels a succession of changes in its direction of flow; and pumping the liquid along the flow path at a sufficient velocity. A succession of changes in direction may be continuous curvature as in concentric or helical flow or may alternate between turning to the right and to the left.

Elastic turbulence occurs in solutions containing a solute which has a flexible structure. One category of material which is able to undergo elastic deformation and enable a solution to display elastic turbulence is a polymer containing long flexible linear chains. The number of monomer units in the polymer may be at least 5000 and may be considerably more such as at least 25,000. The monomer units may be present in linear chains of at least 1000 monomer units which may each be connected one to the next by a single covalent bond, so that one monomer unit can rotate relative to adjoining monomer units. Individual linear chains may be longer, and a polymer may contain a linear chain of at least 5000 or even at least 10,000 monomer units. A polymer chain may contain only one kind of monomer, or the chain may be a copolymer of more than one monomer, for instance, a block copolymer which is linear. A polymer may also include side chains attached to a long chain of monomer units which are connected together by single covalent bonds. If a chain contains units which are themselves an oligomer, as in a block copolymer for instance, the oligomeric units may rotate relative to one another more freely than monomer residues within an oligomeric unit. A polymer may include some chain branching, for instance, at branch points where three or more linear chains, each of at least 1000 monomer units, are connected together. When using a long chain polymer to enable elastic turbulence to occur, it is desirable to include a biocide to protect the long chain linear polymer from biodegradation.

The flexibility of the polymer chains enables the polymer molecules to become entangled. The flexibility of polymer chains can be described by means of a mathematical model. The freely jointed chain model is commonly used, and the flexibility of a particular polymer can be indicated by parameters of an equivalent freely jointed chain (itself a mathematical model). A description of this approach is provided by Chapter 2 of “Polymer Physics” by Rubinstein and Colby, 2003, Oxford University Press. An equivalent freely jointed chain has the same mean-square end-to-end distance and the same maximum end-to-end distance as the actual polymer but is considered to consist of so-called Kuhn monomers which are freely rotatable relative to each other. These model monomers have a length, termed the Kuhn length, and a molar mass.

Polymers to enable elastic turbulence may contain at least one flexible polymer chain with length and composition represented by at least 5000 Kuhn monomers having a Kuhn length not more than 100 Angstroms (10 nm) and possibly not more than 50 Angstroms. If a polymer is a single unbranched chain, its length and composition may correspond to at least 20,000 Kuhn monomers and possibly at least 50,000 Kuhn monomers.

The mean molecular weight of the polymer may be at least one Mega Dalton i.e. at least 10⁶ Daltons, possibly at least 10 Mega Daltons or more. The concentration of such long chain/high molecular weight polymer included in a solution for enabling elastic turbulence to occur may be under 5% by weight, for instance, in a range from 0.05% or 0.1% up to 1% or 2% by weight.

Elastic turbulence has been observed with several different long chain polymers in solution. One such polymer is polyacrylamide, which may be hydrolyzed or partially hydrolyzed. Experimental evidence for elastic turbulence in a solution of high molecular weight polyacrylamide was given by Groisman, A., Steinberg, V., “Elastic turbulence in a polymer solution flow”, Nature 405, 53-55 (2000). Other instances of long chain polymers reported to give rise to elastic turbulence include polyisobutylene of molecular weight 4 to 6 Megadaltons dissolved in an organic solvent (Dris and Shaqfeh, “Experimental and theoretical observations of elastic instabilities in eccentric cylinder flows: local versus global instability”, Journal of Non-Newtonian Fluid Mechanics, Vol 80, Pages 1 to 58 (1998)), polystyrene of molecular weight 18 Megadaltons in an organic solvent (Magda and Larson, “A transition occurring in ideal elastic liquids during shear flow”, Journal of Non-Newtonian Fluid Mechanics, Vol 30, Pages 1-19 (1988)) and polyethylene oxide of molecular weight 4 MegaDaltons in an aqueous solution (Davoodi et al., “Secondary flows due to finite aspect ratio in inertialess viscoelastic Taylor-Couette flow”, Journal of Fluid Mechanics, Vol 857, pages 823-850 (2018)). Kuhn lengths for polystyrene and polyethylene oxide have been reported as 18 Angstroms and 11 Angstroms (Rubinstein and Colby (2003), “Polymer Physics”, Page 53). Kuhn length for polyacrylamides has been reported as 15 to 25 Angstroms (Fetters, Lohse and Colby, “Chain Dimensions and Entanglement Spacings” in Physical Properties of Polymers Handbook, Springer, 2007; pages 447-454).

Long chain partially hydrolyzed polyacrylamide linear polymers with a molecular weight of more than 1 MegaDalton are available from SNF Floerger, whose headquarters are in Andrézieux, France.

Another category of material able to undergo elastic deformation and enable a solution to display elastic turbulence is a viscoelastic surfactant which forms worm-like micelles in solution. There is extensive scientific literature concerning surfactants which form worm-like micelles, their properties and applications. One review is Yang “Viscoelastic wormlike micelles and their applications” Current Opinion in Colloid & Interface Science, Volume 7, pages 276-281 (2002). Discussions of properties include Raghavan and Kaler “Highly Viscoelastic Wormlike Micellar Solutions Formed by Cationic Surfactants with Long Unsaturated Tails” Langmuir, Vol 17, Pages 300-306 (2001) and Beaumont et al, “Turbulent flows in highly elastic wormlike micelles”, Soft Matter, Volume 9, Page 735-749 (2013). An example, using cetyl trimethyl bromide as the surfactant, is mentioned by Fardin et al., “Elastic Turbulence in Shear Banding Wormlike Micelles” Physical Review Letters, 104, 178303 (2010).

When a solution contains a substance able to cause elastic turbulence, the phenomenon of elastic turbulence occurs if the solution is flowing at a sufficient flow velocity (which may be a low velocity) and the path of flow causes the streamlines of the flow to curve. Consequently, one known possibility for a flow path which induces elastic turbulence is a serpentine channel. Another possibility is a flow path with obstructions which compel the streamlines of flow to change direction. Such obstructions may be manufactured and arranged in a pattern so as to compel flow around the obstructions to change direction.

A porous material can also provide a flow path which causes a succession of changes of direction. Changes in the directions of pores and connections between pores can compel changes of flow direction. A porous material may be fibrous and the openings between the fibers will provide tortuous flow paths with a succession of changes of direction.

The ability of a fluid composition to display elastic turbulence can be shown experimentally using a laboratory rheometer. In a cone and plate rheometer cell, the onset of elastic instability with application of increasing shear is observed as an apparent increase in viscosity at a particular shear rate associated with an abrupt increase in the noise in the measured torque signal. This has been described by D. O. Olagunju, “Instabilities and bifurcations of von Karman similarity solutions in swirling viscoelastic flow” in Z Angew Math Phys, 46 (1995) 224-238 and also by E. Tran, A. Clarke, “The relaxation time of entangled HPAM solutions in flow”, Journal of Non-Newtonian Fluid Mechanics, 311 (2023) 104954. The apparent increase in viscosity can be seen as a change in the slope (sometimes referred to as an uptick) in the plot of viscosity against shear rate.

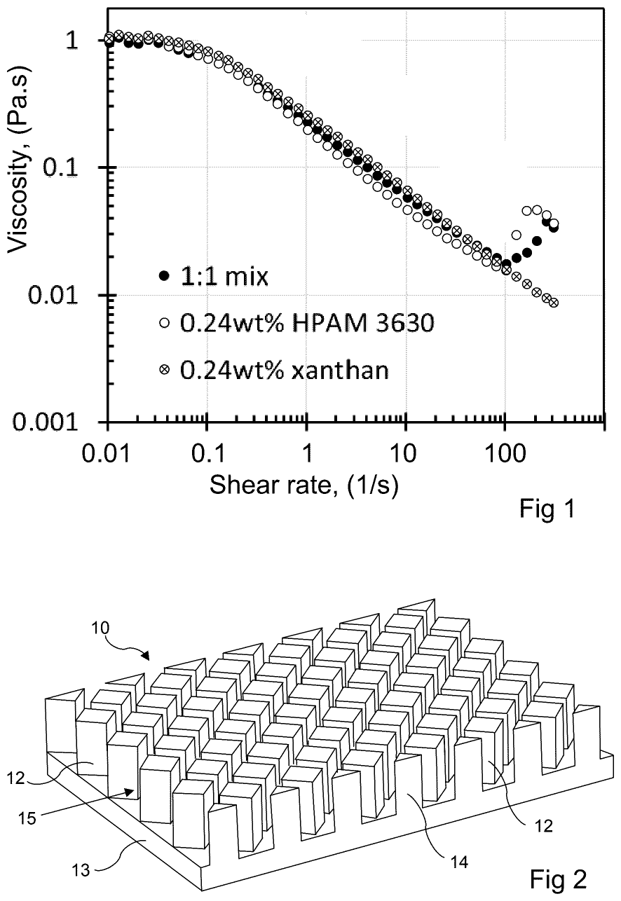

FIG. 1 shows results from experimental tests carried out with a laboratory rheometer operated to take measurements at increasing steps in shear rate and then at decreasing steps. It is a plot of dynamic viscosity against increasing shear rate for three aqueous solutions each containing 0.456 wt % sodium chloride, a small percentage of a linear polyacrylamide with molecular weight above 10 MegaDaltons and a few drops of a biocide consisting of isopropanol and thiourea. In one of these aqueous solutions (points in FIG. 1 shown as open circles) the polymer was 0.24 wt % of Flopaam3630 from SNF Floerger which is polyacrylamide with a mean molecular weight of 18 to 20 MegaDaltons. In a second of these solutions (points shown as circles containing a cross) the polymer was 0.24 wt % xanthan. In the third of these solutions (points shown as filled circles) the polymer was 0.12 wt % Flopaam 3060 and 0.12 wt % xanthan, i.e. a 1:1 mix. The solutions containing polyacrylamide, either alone or in mixture with xanthan, showed a distinct change in slope of the plotted curve, seen at approximately 150 s⁻¹. This indicated the onset of elastic turbulence with increasing shear rate. The solution containing xanthan had no such change of slope, indicating that this more rigid polymer did not enable elastic turbulence to occur.

A similar experiment used a solution containing 0.2 wt % of Flopaam 6040, also from SNF Floerger, with a mean molecular weight between 25 and 30 MegaDaltons. Here also the onset of elastic turbulence with increasing shear rate was seen as a change in slope of the plotted curve at approximately 150 s⁻¹ indicating the onset of elastic turbulence. (Shear rates for the onset of elastic turbulence in electrochemical half-cells may be lower).

FIGS. 2 to 5 relate to experimental demonstrations of elastic turbulence in aqueous solutions of viscoelastic surfactant and also in aqueous solutions of a flexible polymer.

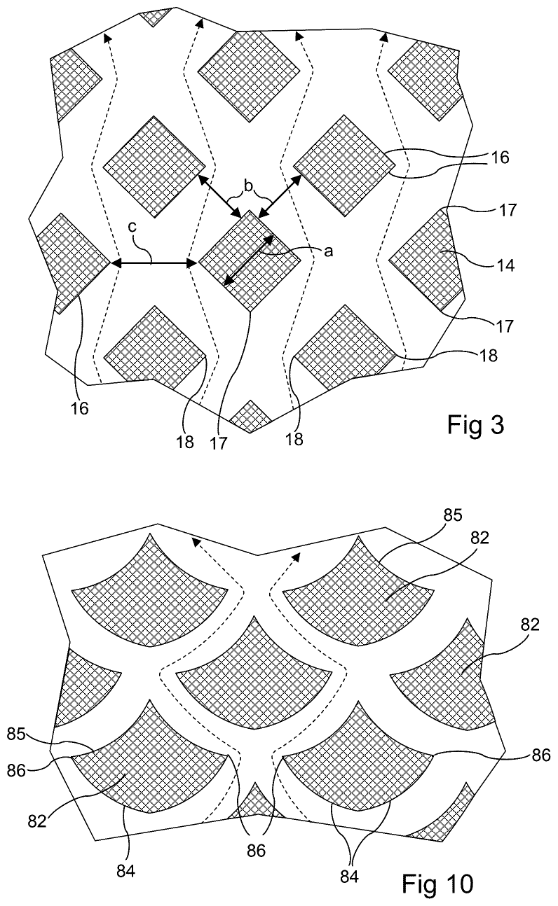

FIG. 2 shows a flow guide 10 used in these experiments. It has a regularly spaced array of pillars 12 of square cross section integral with a base 13. Two edges of the array are completed with pillars 14 which have a triangular cross section. FIG. 3 is an enlarged top view of a portion of the flow guide. As shown, the pillars 12 each have a square cross section with flat faces 16 meeting at corner edges 17 and 18. The width of a flat face 16 is indicated as “a” in FIG. 3 and the spacing between the faces 16 of adjacent pillars is indicated as “b”. The width of the gap between two confronting edges 18 is of course given by Pythagoras theorem as √2b². Each pillar 12 is positioned so that the diagonal across the square cross section between corner edges 17 is aligned with the overall direction of flow. As indicated by broken lines, liquid flows through the gaps between confronting edges 18 of adjacent pillars 12 but is then compelled to turn by pillars downstream. Thus, the array of pillars 34 obstructs straight line through flow of liquid, causing the streamlines of the flow to change direction repeatedly.

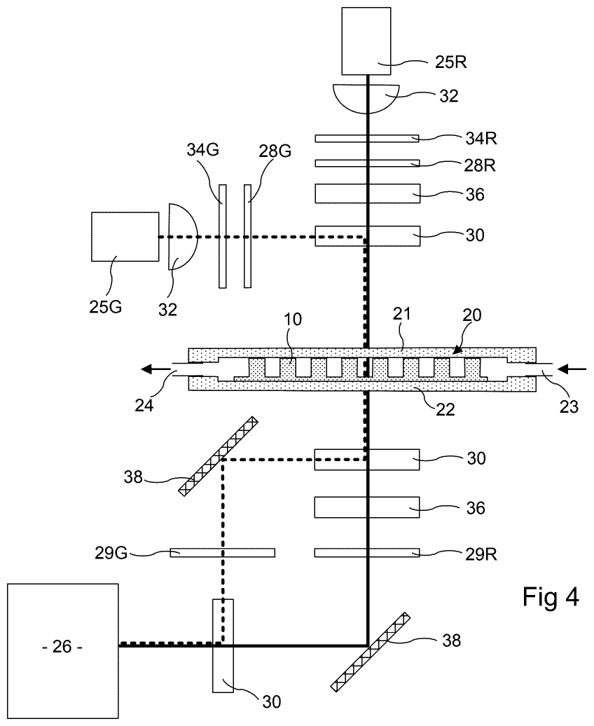

The flow guide 10 is made of transparent polymer and is located within a chamber 20 which is shown in cross section in FIG. 4. The chamber 20 is formed by two blocks of transparent polymer, 21, 22 held together by bolts which are not shown. The flow guide 10 is in a cavity between the two blocks. There is a liquid inlet 23 to the cavity and a liquid outlet 24. When liquid is pumped through the chamber 20, the liquid enters the flow guide 10 at the end indicated 15 in FIG. 2 and then flows through the gaps between the pillars 12. The repeated changes in direction can cause elastic turbulence to occur, if the liquid contains a substance able to display elastic turbulence and the flow velocity is sufficient.

The occurrence of elastic turbulence was observed using a technique utilizing the phenomenon of birefringence. The apparatus is shown in FIG. 4. It has some similarity to apparatus described by Moss GR and Rothstein JP in “Flow of wormlike micelle solutions through a periodic array of cylinders”, Journal of Non-Newtonian Fluid Mechanics, Vol 165, pages 1-13, 2010.

Beams from a red LED light 25R and a green LED light 25G are directed along paths, respectively shown as a solid line and as a broken line, towards a video camera 26. The chamber 20 is positioned between linear polarizing filters 28R, 29R set with their polarization directions at right angles (i.e. crossed) and between linear polarizing filters 28G, 29G which are also set with their polarization directions at right angles to each other. Consequently, no light can reach the video camera 26 unless birefringence in the chamber 20 alters the angle of polarization of light as it passes through the chamber. The filters 28R and 28G are set with their polarization directions at right angles to each other, so that the planes of polarization of the red and green light entering the chamber 16 are at right angles to each other. Dichroic mirrors 30 which pass the red beam and reflect the green beam are used to merge the red and green beams, then to separate them after they have passed through chamber 20, and subsequently to reunite them before they arrive at the camera 26.

Other parts of the apparatus are mirrors 38, lenses 32, red and green bandpass filters 34G and 34R and dichroic mirrors 36 which are set with a 90° difference in rotation with respect to the red beam path in order to cancel rotation of polarization induced due to Fresnel refraction. Such dichroic mirrors were not needed for the green beam because its polarization is such that no rotation of polarization was induced.

Wormlike micelles formed by viscoelastic surfactants are birefringent. Consequently, when these molecules become aligned by liquid flow within the chamber 20 and are illuminated with polarized red and green light, they can change the plane of polarization of the light thereby allowing some of this light to pass through the filters 29R and 29G to the camera, although this will not occur if the alignment of the micelles coincides with the plane of polarization of the light. Providing two light beams with different planes of polarization as they enter the chamber 20 addresses this issue: if micelles happen to be aligned with the red polarization, they will not be aligned with the green polarization and vice versa. Hence the apparatus is sensitive to polarization alignment in any direction.

When there is flow of a liquid containing wormlike micelles through the chamber, these micelles become aligned through extensional flow as the liquid flows around the pillars 12, 14 of the flow guide 10, and the birefringence from the aligned micelles can be seen as red or green color in pictures or video recorded by the camera 26.

A first experiment was carried out using a solution similar to one mentioned by Moss and Rothstein in the paper above. This solution contained 100 mM (approx. 4 wt %) of the viscoelastic cationic surfactant cetylpyridinium chloride and 50 mM (approx. 0.8 wt %) of sodium salicylate dissolved in a brine of 100 mM (approx. 0.6 wt %) NaCl in distilled water.

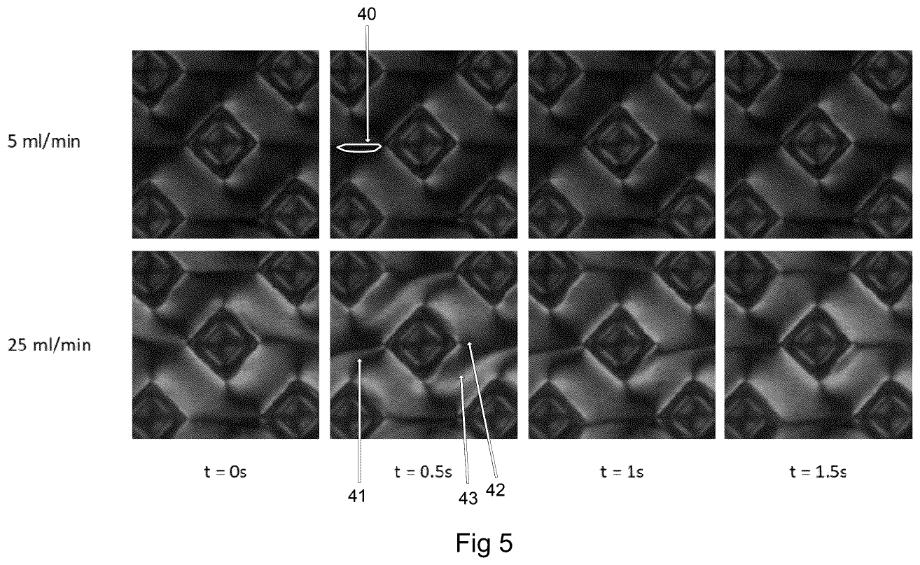

The viscoelastic solution was pumped through the chamber 20 at a low flow rate of 5 ml per minute. The camera 26 recorded video at twenty frames per second for a period of 5 seconds and the recording showed that the pattern of flow around the pillars of the flow guide remained constant. Four pictures from that video recording, at half second intervals, are shown in grayscale as the top row in FIG. 5 and it can be seen that there is negligible change from one picture to the next. The original colored pictures showed a line of red color extending in the flow direction from the downstream corner of each pillar. A white outline has been drawn around one of these indicated 40 in one picture. These lines of red color remained at the same intensity and in the same position throughout the video recording. The flow rate was then increased to 25 ml/min and video was again recorded for 5 seconds. This video recording of flow at 25 ml/min was very different from that at 5 ml/min. It showed constant movement. Patches of color, which is where extensional flow was aligning micelles, were constantly moving from one position to another and varying in intensity. Four pictures from the video with 25 ml/min flow rate are reproduced in grayscale as the bottom row of FIG. 5. There are a number of changes from each picture to the next. For instance, arrow 41 points to a patch of red color which was present in one picture but absent from the preceding picture and diminished in the two subsequent pictures. At the position 42 there was an area of red color which was not present in the preceding picture and again diminished in the next two pictures. The second picture in the lower row also shows an intense green area 43 which was not present in the first picture and which largely disappeared in the third picture. Thus, it could be seen that flow at 5 ml/min was laminar but at 25 ml/min the flow had become turbulent.

Similar experiments were carried out with a solution containing partially hydrolyzed polyacrylamide of average molecular weight 18 MDa (HPAM) to enable the display of elastic turbulence and xanthan as an additional thickening agent, and with a comparative solution containing only xanthan (which is too rigid to cause elastic turbulence, as mentioned above). These polymers do not form micelles but do cause birefringence when aligned. Flow rates and observations are given in the following table which also includes the comments from the above experiment with viscoelastic surfactant.

| Solutes | Flow rate | Comments concerning pictures |
|---|---|---|
| 4 wt % cetyl pyridinium | 5 ml/min | Red lines extending downstream from pillars do |
| chloride | | not change position. No changes in overall |
| 0.8 wt % sodium | | appearance |
| salicylate and | 25 ml/min | Red lines extending downstream from pillars |
| 0.6 wt % sodium | | change angle relative to flow direction. Green |
| chloride | | areas appear, change position and disappear. |
| 0.25 wt % HPAM and | 5 ml/min | Red lines extending downstream from pillars do |
| 0.25 wt % xanthan | | not change position. Green areas do not change. |
| | 15 ml/min, | Movement of red areas extending downstream |
| | and 30 ml/min | from pillars, prominent green areas appear and |
| | | change position |
| 0.5 wt % xanthan | 5 ml/min, | Red and green areas do not change position at |
| | 30 ml/min and | any flow rate |
| | 40 ml/min | |
| 0.25 wt % xanthan | 30 ml/min | Red and green areas do not change position |
| 0.12 wt % HPAM, | 5 ml/min | Red and green areas do not change position |
| 0.12 wt % xanthan, | 45 ml/min | Red and green areas change in shape and position |
| 0.465 wt % NaCl | | |

It is apparent from these comments that the solution containing HPAM and xanthan displayed elastic turbulence at 15 ml/min and above, but solutions containing xanthan without HPAM did not display elastic turbulence even at 30 ml/min.

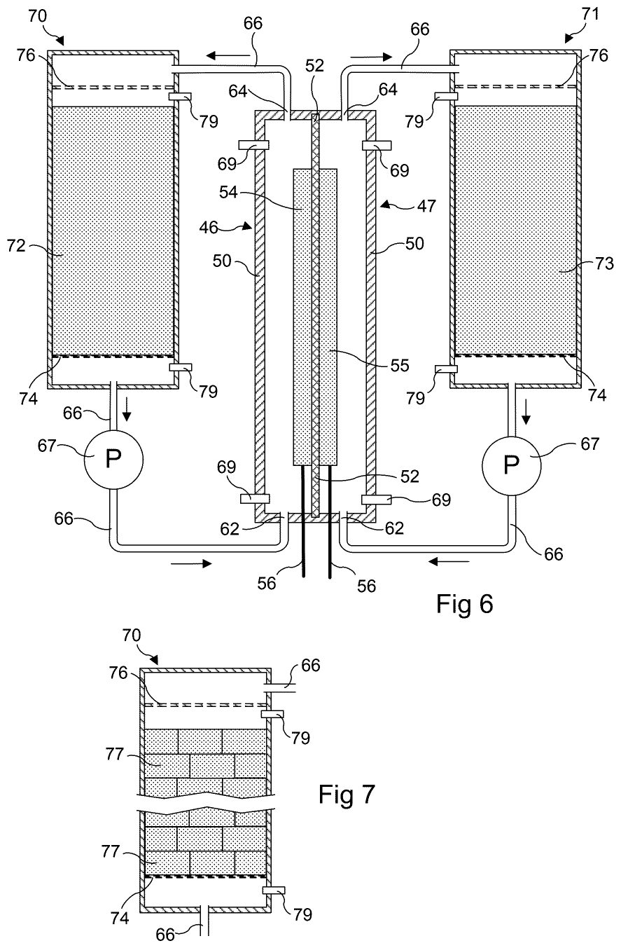

FIG. 6 shows diagrammatically the component parts of a redox mediated flow battery in which both half-cells and vessels connected to them have similar layout. The battery has two half-cells 46, 47 within a casing 50. The half-cells are at either side of a separator which is membrane 52 (shown with exaggerated thickness). The half-cell 46 shown to the left of the membrane contains the negative electrode 54 of the overall cell. The half-cell 47 shown to the right of the separator 52 contains the positive electrode 55. Both of these electrodes 54 and 55 are formed of electrically conductive porous material which may be a fibrous material which has been carbonized, so that it contains numerous carbon strands packed together and has high surface area. Electrical connections to the electrodes are indicated at 56.

The flow battery comprises two supply vessels 70, 71 each of which is packed with a bed 72, 73 of solid material in granular form resting on a supporting grid 74. The outlet 64 of each half-cell is connected by piping 66 to the upper part of one of the vessels 70, 71. The bottom outlet of each vessel 70, 71 is connected by further piping to a pump 67 which is connected to the inlet 62 of the half-cell. Thus, each half-cell and the vessel 70 or 71 connected to it are parts of a flow circuit. Each flow circuit is filled with an electrolyte liquid and the pump 67 circulates this liquid into and through the half-cell, then from the outlet 64 of the half-cell to the vessel 70 or 71 where the liquid flows through the bed 72 or 73 of granular material. Each vessel 70, 71 has a plate 76 with through holes positioned above bed 72, 73. This plate 76 distributes the flow of electrolyte liquid across the upper surface of the bed 72, 73.

The paths of flow between solid granules of the beds 73 and 74 compel the flow to make many changes of direction. In accordance with this disclosure, the electrolyte liquid flowing within each flow circuit includes a solute which enables the liquid to display elastic turbulence. This may be a high molecular weight linear polymer which is flexible and able to undergo elastic deformation or may be a viscoelastic surfactant which forms wormlike micelles, as discussed above. The pumping power is chosen to give flow speeds which are sufficient for this solute to cause elastic turbulence in the vessels 70, 71 where the flow is compelled to make repeated changes of direction, although flow entering the vessels 70, 71 is laminar. This elastic turbulence within the beds 73, 74 mixes the liquid as it flows, transports the reactive species in solution in the liquid into contact with the insoluble reactive species in the bed 72 or 73 and also transports the soluble products of reaction away from the insoluble species.

There are a number of published electrochemical systems which can be used in a flow battery as shown by FIG. 6 and examples are given below.

### Example 1

This example shows how a battery as shown in FIG. 6 could be configured to use a chemical system which has been operated at experimental scale and published by Yu et al in “Redox Targeting-Based Aqueous Redox Flow Lithium Battery” ACS Energy Letters, Vol 3, page 2314 (2018).

The vessel 70 contains a bed 72 of an insoluble reactive species which is insoluble granules of LiTi₂(PO₄)₃ with mean diameter 1.5 mm. The electrolyte liquid in this vessel and the half-cell 51R is a solution containing 1 molar Li₂S₂ as soluble reactive species and 0.1 molar LiOH in water. The electrode 55 is carbon felt. The vessel 71 contains a bed 73 of an insoluble reactive species which is granules of LifePO₄ with a mean diameter of 1 mm. The electrolyte liquid in this vessel and the half-cell 46 is a 0.3 molar solution of the soluble reactive species K₄Fe(CN)₆ in a mixture containing 70 vol % water and 30 vol % tetraethylglycol dimethyl ether (TEGDME). The electrode 54 is carbon felt with a coating of Cu₂S. The separator membrane 52 is a cation exchange membrane allowing the passage of lithium ions.

Both of the electrolyte liquids contain an additive which is high molecular weight polyacrylamide such as Flopaam 3060 or a viscoelastic surfactant such as cetyl trimethyl bromide. The concentration of this additive and the pumping power are such that elastic turbulence occurs during flow through the half-cells 46, 47 and vessels 70, 71. Suitable concentrations for this have been mentioned above and a procedure for determination of suitable pumping power is given below.

During charging of the battery, disulfide ions are converted to sulfide ions at the electrode 54, thus

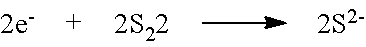

The sulfide ions are carried by the flow into the vessel 70 where reaction of the sulfide ions and the insoluble LiTi₂(PO₄)₃ granules converts it to Li₃Ti₂(PO₄)₃ and the sulfide reverts to disulfide, thus

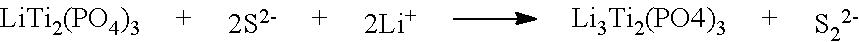

The reaction at the electrode 55 is

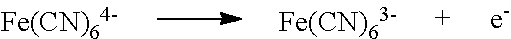

The flow carries the ferricyanide ions into the vessel 71 where reaction of these Fe(CN)₆³⁻ ions and the insoluble LiFePO₄ converts the LifePO₄ to FePO₄ and lithium ions while the ferricyanide ions revert to ferrocyanide, thus

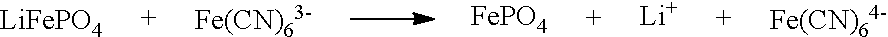

During discharge all of the above reactions go in the reverse direction. During charge and discharge lithium ions migrate through the membrane 52 from one half-cell to the other. The elastic turbulence enhances mass transport in the vessels 70, 71 while allowing pumping power and flow speeds to be low enough that there is laminar flow outside the vessels 70, 71.

### Example 2

This example shows how a battery as shown in FIG. 6 could use a chemical system containing both organic and inorganic compounds. This system has been published by Zhou et al. as “Single-Molecule Redox-Targeting Reactions for a pH-Neutral Aqueous Organic Redox Flow Battery”, Angew. Chem. Int. Ed; 59, 14286 (2020).

The vessel 70 contains a bed 72 of an insoluble polyimide containing aromatic keto groups which can be reduced to phenolic hydroxyl (i.e. hydroxyl as a substituent on an aromatic ring). The polyimide is cut into small stick shapes whose longest dimension is about 2 mm. The electrolyte liquid is a pH neutral aqueous solution containing 0.2 molar 9,10-anthraquinone-2,7-disulphonic acid (referred to as 2,7-AQDS) as its sodium salt and 0.5 molar sodium sulfate. During charge keto groups of the 2,7-AQDS are reduced to phenolic hydroxyl at the electrode 54 and then in the vessel 70 there is spontaneous reaction between the reduced 2,7-AQDS and the polyimide, in which keto groups of the polyimide are reduced and the 2,7-AQDS reverts to its previous form.

The vessel 71 contains a bed 73 of nickelhexacyanoferrate (referred to as NIHCF) as small stick shapes in which the NIHCF is mixed with carbon black and an inert polymer binder. The electrolyte liquid contained 0.2 molar sodium iodide and 0.05 molar iodine in a 0.5 molar sodium sulphate solution. During charge iodide ions are converted to tri-iodide at the electrode 55

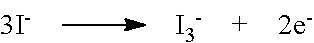

and in the vessel 71 the tri-iodide ions spontaneously react with the NIHCF converting some of its iron atoms from ferrous to ferric while reverting to iodide.

During discharge these reactions all go in the reverse directions. During charge and discharge sodium ions pass through the membrane separator. As in the previous example, both of the electrolyte liquids contain an additive which is high molecular weight polyacrylamide such as Flopaam 3060 or a viscoelastic surfactant such as cetyl trimethyl bromide.

### Example 3

This example shows a system in which one vessel and associated half-cell use one soluble reactive species during charging but a different reactive species during discharge. This system has been published by Paez et al in “The Redox-Mediated Nickel-Metal Hydride Flow Battery”, Advanced Energy Materials, Vol 12, 2102866 (2022).

The vessel 70 contains a bed 72 of granules of so-called “metal hydride”. This is a metal alloy, commonly LaNi₅, which can absorb hydrogen and has been widely used for manufacture of NiMH rechargeable batteries for portable devices. The electrolyte liquid contains two electrochemically reactive compounds 2,6-dihydroxyanthraquinone (DHAQ) and 7,8-dihydroxyphenazine-2-sulfonic acid (DHPS). Both of these compounds contain aromatic keto groups which can be reduced to phenolic hydroxyl groups. Their redox potentials are slightly above and slightly below that of the solid metal hydride. The aqueous solution is 0.2 molar DHAQ and 0.2 molar DHPS in 1.5 molar KOH.

During charge, DHPS is reduced at the electrode 54. When the reduced DHPS is carried by the flow into vessel 70 it reacts with the metal alloy so that the hydrogenation of this alloy is increased while the DHPS reverts to its original form. During discharge the metal hydride reacts with the DHAQ. The metal hydride reduces the keto groups of the DHAQ to hydroxyl while itself reverting to its original state. The DHAQ is then carried by the flow into the half-cell 47 where it reverts to its original form by reaction at the electrode 55.

The vessel 71 contains a bed of nickel hydroxide in particulate form. The electrolyte liquid in this vessel and the half-cell 47 is a 0.3 molar solution of K₄Fe(CN)₆ in 1.5 molar aqueous KOH. During charge this is converted to K₃(Fe(CN)₆ at the electrode 55 and when this is carried into the vessel 71 it reacts with the nickel hydroxide converting it to NiOOH while itself reverting to its original form. These reactions go in reverse during discharge of the battery.

FIG. 7 shows a possible variation of the system shown by FIG. 6. The solid material in the supply vessel 70 comprises blocks 77 of porous material, arranged with the blocks in one layer overlapping blocks in the layer below so that flow is compelled to pass through the porous blocks rather than between them. As with the packing of solid granules shown in FIG. 6, the flow paths through the porous material make frequent changes of direction, enabling flow of the liquid as mentioned above through the blocks 77 to be in a state of elastic turbulence.

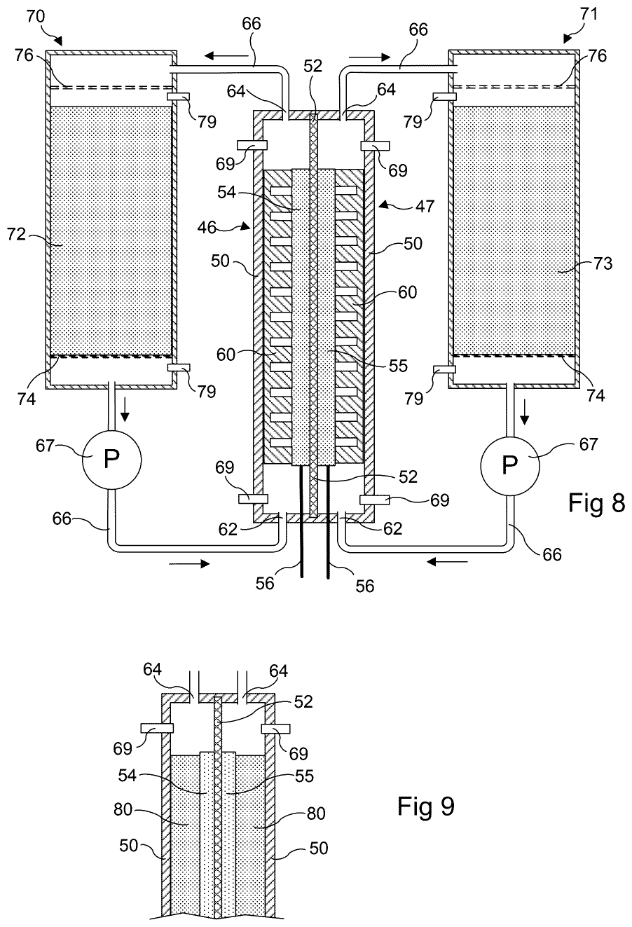

FIG. 8 is generally similar to FIG. 6 and the same reference numerals are used for the same parts. The difference from FIG. 6 is that each half-cell contains a flow guide 60 which has an array of spaced pillars of square cross section integral with a base in the manner shown by FIG. 2 although this flow guide 60 may have a longer and wider array of pillars than are shown in FIG. 2. In each half-cell the tops of the pillars are adjacent to the electrode 54 and 55. As an electrolyte liquid passes through a flow guide 60 in the half-cell, the pillars of the flow guide 60 cause the streamlines of the flow to change direction many times and thereby cause elastic turbulence to occur. This mixes the electrolyte as it flows, transports the electrochemically active species into contact with the surfaces of the porous electrode and transports the products of reaction away from those surfaces. The increased transport of chemical species as a result of elastic turbulence will increase the maximum current flow in the half-cell, compared with a half-cell of the same construction but without the polymer or surfactant in the electrolyte fluid.

It may be possible to calculate the Reynolds number for flow through a flow guide with a regular array of obstructions to compel changes of flow direction. The viscosity of the liquid, the flow rate of the liquid and the width of the gaps between obstructions may give a Reynolds number for the flow which is in a range from 1 to 1000 and possibly 1 to 500 or 1 to 250.

Some variations to the half-cells 46, 47 are possible. The flow guides 60 may be made of a material which is an electrical insulator. Another possibility is for these flow guides to be made of metal or have a metallic surface coating, with the connections 56 going to the conductive flow guides. This possibility uses the flow guides 60 to distribute the supply of electric current to the electrodes 54 and 55.

A further possibility, shown in by FIG. 9 replaces the flow guides 60 with electrically conductive porous material 80 which may be carbon fibers, carbon fibers with a metal coating or a non-woven mesh of thin metal wires.

If a flow guide is used, it may have different shape from the array of pillars shown in FIGS. 2 and 3, and in particular other shapes of pillars can be used. This is illustrated by FIG. 10 which shows pillars 82 with another possible cross section. The surfaces 84 have convex curvature and intersect concave surfaces 85 at edges 86. Electrolyte liquid flows through the gaps between edges 86 as shown by the broken lines and is compelled by the arrangement of pillars 82 to change direction as it does so.

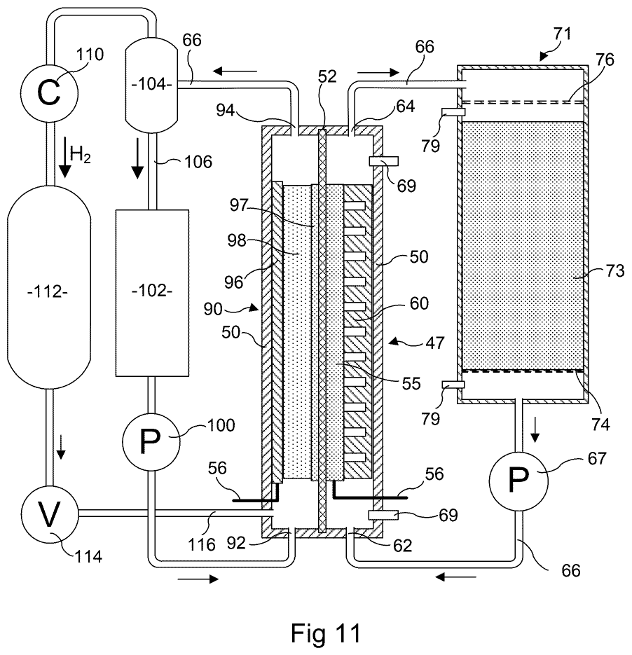

FIG. 11 shows a system with two half-cells of different kinds. The two half-cells are enclosed with a casing 50. The half-cell at the right of the separator is the same as the half-cell 47 shown in FIG. 6 and is connected to a vessel 71 as in FIG. 6. It contains the positive electrode 55. The part of the system at the left of the separator membrane is a regenerative fuel cell. It has a half-cell 90 within the casing 50 and the two half-cells 90, 47 are separated by an ion exchange membrane 52.

The half-cell 90 produces hydrogen during charging and consumes that hydrogen as fuel during discharge. The half-cell 90 has a bottom inlet 92 and a top outlet 94 and contains an electrode assembly which comprises a conductive current carrier 96 and two porous layers. These are a thin layer 97 of porous material which is positioned next to the separator membrane 52 and has a reaction catalyst deposited on its surface. Between this catalyst layer 97 and the current carrier 96 is a further porous layer 98 through which flows both the electrolyte liquid and hydrogen.

During both charge and discharge a pump 100 propels electrolyte liquid from storage vessel 102 through piping to the inlet 92 of half-cell 90. When charging, i.e. when electric current is supplied to the overall system, hydrogen is produced at the catalyst layer 97 and a mixture of electrolyte liquid and hydrogen gas leaves the half-cell 90 at its outlet 94 from where it flows to a gas/liquid separator 104. Electrolyte liquid is returned along pipe 106 to the storage vessel 102 while hydrogen gas leaves from an upper outlet of the gas/liquid separator 104 and is pumped by compressor 110 into pressure vessel 112 where it is stored. While discharging electric current, hydrogen gas is released from the pressure vessel 112 through regulating valve 114 and returned through an inlet pipe 116 to the lower end of the half-cell 90. The hydrogen gas is converted back to hydrogen ions at the catalyst layer 97.

In accordance with this disclosure, and as in the embodiments described above, the electrolyte liquid flowing through the half-cell 47 and vessel 71 includes a dissolved additive which enables the liquid to display elastic turbulence.

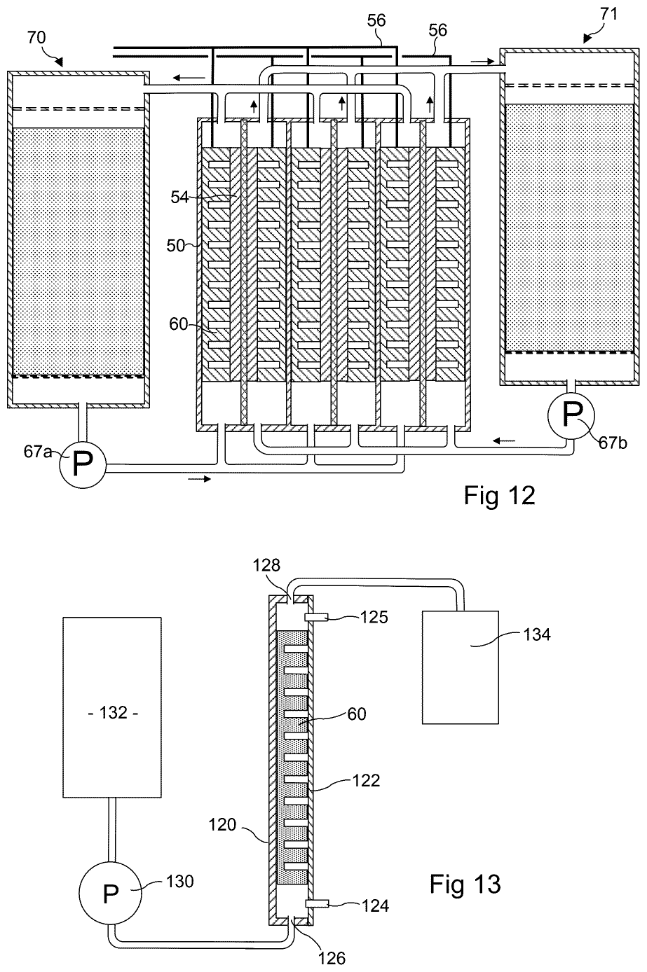

A number of flow batteries may be connected together and may share vessels which contain the insoluble species. This is illustrated by FIG. 12 which shows three electrochemical cells arranged side by side. Each of the half-cells is largely as shown and described in FIG. 8, but the flow guides 60 are electrically conductive and used to carry electric current to and from the electrodes. The electrical connections 56 lead to the flow guides 60. The electrochemical cells are shown connected electrically in parallel, although connection in series is also possible. The pump 67a connected to vessel 70 is connected to pump electrolyte liquid into the half-cells 46 at the left of the separators 52. Likewise, the pump 67b connected to vessel 71 is connected to pump electrolyte liquid through the half-cells 47 at the right hand of each separator 52.

For electrochemical half-cells as described above, with a polymer or surfactant present in an electrolyte liquid, a flow rate able to cause elastic turbulence to occur may be found by monitoring electric current while progressively increasing the flow rate. When elastic turbulence begins the improved mass transport will lead to an increase in current flow.

However, it is also possible to determine a suitable flow rate through a half cell or through a supply vessel such as 70, 71 before constructing and operating a complete system. This is illustrated by FIGS. 13 to 15. As shown in FIG. 13, a structure 120 with the dimensions of a proposed half-cell contains a proposed flow guide 60 of the type shown in FIG. 8. No separator or membrane is present. Instead, a plate 122, is fitted against the tops of the pillars 12 of the flow guide 60. Pressure sensors 124 and 125 are fitted at the inlet and outlet regions of the structure 120. The inlet 126 is connected to a pump 130 which delivers fluid from a tank 132 which is maintained at a fixed temperature. This fluid should be the same as the fluid which is intended to flow through the half-cell. The outlet 128 is connected to a graduated vessel 134 for measuring volume of liquid which has been pumped through the flow guide 60 in a chosen interval of time and thereby determining the flow rate.

When liquid from the tank 132 is pumped through the structure 120 containing flow guide 60 there will be a pressure drop between the inlet pressure sensor 124 and the outlet pressure sensor 125. When the flow rate is very low, the flow will be laminar, without any elastic turbulence. The minimum flow rate to cause elastic turbulence in the half-cell can be found by progressively increasing the pump speed to increase the flow rate and plotting the pump speed, which increases with pressure drop, against flow rate. This plot will show a change in slope on reaching the flow rate at which elastic turbulence begins.

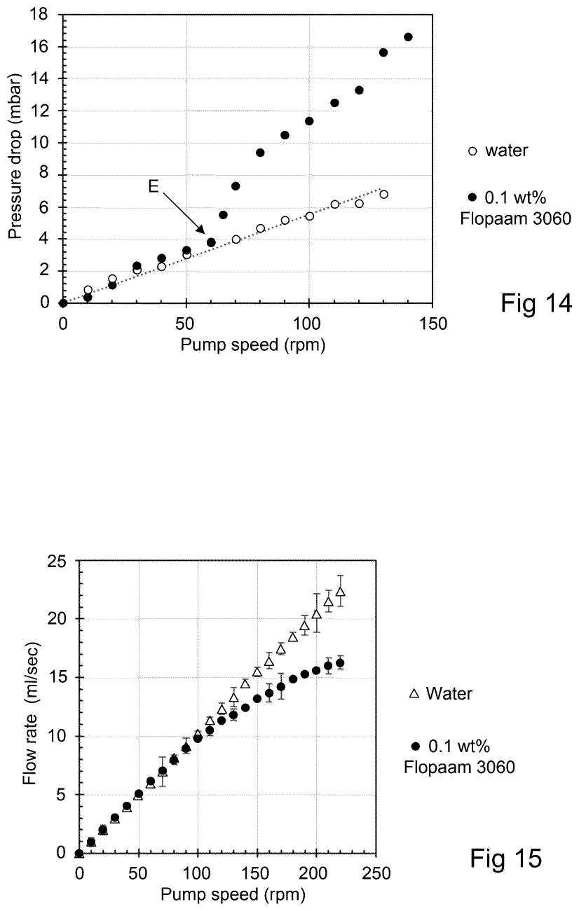

This is illustrated by the following description of experimental work with apparatus similar to that shown. The results of the experiments are shown in FIGS. 14 and 15. An initial calibration determines relationships between pump speed and flow rate. The tank 132 was filled with water. The pump 130 was used to propel water through the structure 120 containing flow guide 60 at progressively increasing flow rate. The pump speeds and the flow rates measured downstream of the structure 120 were recorded and are shown in FIG. 15 (triangle points). This calibration procedure was then repeated with an aqueous solution containing 0.1 wt % of Flopaam 3630 polyacrylamide dissolved in the liquid in the tank 132. This gave the non-linear plot also shown in FIG. 14 (circular points).

FIG. 14 shows the measured flow rates plotted against pump speed. With water the plot was approximately linear (as would be expected because water is a Newtonian fluid) but with the polyacrylamide solution there was a very sharp change in the slope of the plot at the point E, indicating that the flow rate at this point was the minimum required to cause elastic turbulence with that polyacrylamide solution and apparatus.

Measurements of this kind make it possible to estimate Reynolds' number for flow through a flow guide 60. The formula which may be used to determine Reynolds number (Re) for flow through a chamber containing obstructions so as to compel the flow streamlines to bend is:

$$R e = \frac{ρ U L}{η}$$

where ρ is density of the fluid in Kg per cubic metre,
U is the flow velocity in metres per second,
L is the width of the gaps between the obstructions in the chamber, and
η is the viscosity of the fluid in Pascal·sec.

If the flow rate is measured as volume in unit time, the formula above becomes:

$$R e = \frac{ρ QL}{η A}$$

where Q is the flow rate in cubic metres per second and A is the cross-sectional area, transverse to the overall direction of flow, through which the flow passes.

In an example flow guide having geometry as shown in FIGS. 2 and 3, the flat faces 12 of the pillars had a width “a” of 4 mm and the height of the pillars was 7 mm. The spacing “b” between the faces 16 of adjacent pillars was 2 mm and so the gaps between adjacent edges 18 was √8=2.83 mm. A full line of pillars transverse to the overall direction of flow contained 12 pillars with 11 gaps between edges 44, and so the cross section available for flow was

$$11 \times 7 \times 2.83 {mm}^{2} = 11 \times {7.1}^{- 3} \times 2.83 . {10}^{- 3} {m}^{2} .$$

Flow rate was measured as 75 ml·sec⁻¹=7.5×10⁻⁵ m³ sec⁻¹. Density of the liquid was 1000 kg/m³; viscosity was 0.008 Pa·sec. Putting these numbers into the formula mentioned above:

$$R e = \frac{ρ QL}{η A} = \frac{1000 \times 7.5 . {10}^{- 5} \times 2.83 . {10}^{- 3}}{8. {10}^{- 3} \times 11 \times 7. {10}^{- 3} \times 2.83 . {10}^{- 3}}$$

which is Re=12.17.

In embodiments of this disclosure where a flow guide is used, the rate of flow through the flow guide may be such that the Reynolds number is at least 1 or 2 but not more than 250. These are Reynolds numbers at which a Newtonian liquid with no additive to enable elastic turbulence would be in a state of laminar flow.

Various embodiments of this disclosure have been set out above. These are intended to assist understanding of this disclosure, but not to limit it in any way. It should be appreciated that any features or possibilities described in combination may, where it is practical to do so, be used individually. Also, features or possibilities mentioned in the following claims or described in any embodiment may be used in any other embodiment, in so far as it is practical to do so and where two or more of the following claims are dependent on the same preceding claim, the reader should understand that the present disclosure includes any possible combination of any two or more or all of those dependent claims with each other and also with that preceding claim.

1. A battery system comprising:
an electrochemical half-cell comprising an electrode, a liquid containing a first reactive substance dissolved therein which is able to undergo an electrochemical reaction at the electrode, and structure defining a flow path to carry flow of the liquid into contact with the electrode;
a vessel containing a porous mass comprising a reactive substance which is a solid and is insoluble in the liquid, the vessel and the porous mass defining a flow path to carry flow of the liquid through the porous mass;
at least one pump; and
piping connecting the pump, the vessel and the half-cell for the pump to circulate the liquid from the vessel to the half-cell, through the half-cell and back to the vessel, wherein the dissolved and insoluble reactive substances are such that when electric current is supplied to charge the battery system while the pump is circulating the liquid, a first dissolved reactive substance is converted at the electrode to a second dissolved reactive substance which subsequently reacts in the vessel with the insoluble solid reactive substance in which reaction the insoluble solid reactive substance is converted from a first state to a second state and the second dissolved reactive substance is converted back to the first dissolved reactive substance,
and during discharge of electric current from the battery system while the pump is circulating the liquid, the insoluble solid reactive substance in the vessel undergoes reaction with a reactive substance dissolved in the liquid, in which reaction the insoluble solid reactive substance reverts from its second state to its first state and the dissolved reactive substance is converted to another dissolved reactive substance and subsequently that conversion is reversed by electrochemical reaction at the electrode;
and further wherein;
the liquid contains a solute enabling the liquid to display elastic turbulence; and
the flow path through the porous mass in the vessel is configured to compel changes in the direction of liquid flow, to cause elastic turbulence of the liquid in contact with the insoluble solid reactive substance in the porous mass within the vessel.

2. The battery system of claim 1, wherein during the discharge of electric current from the battery system while the pump is circulating the liquid, the insoluble solid reactive substance undergoes reaction with the first reactive substance dissolved in the liquid, in which reaction the insoluble solid reactive substance reverts from its second state to its first state and the first dissolved reactive substance is converted to the second dissolved reactive substance and subsequently the second dissolved reactive substance is converted back to the first dissolved reactive substance at the electrode.

3. The battery system of claim 1, wherein during the discharge of electric current from the battery system while the pump is circulating the liquid, the insoluble solid reactive substance undergoes reaction with a third reactive substance dissolved in the liquid, in which reaction the insoluble solid reactive substance reverts from its second state to its first state and the third dissolved reactive substance is converted to a fourth dissolved reactive substance and subsequently the fourth dissolved reactive substance is converted back to the third dissolved reactive substance at the electrode.

4. The battery system of claim 1, wherein the liquid flow path in the first half cell is configured to compel changes in the direction of liquid flow, to cause elastic turbulence within flow of the liquid in contact with the electrode.

5. The battery system of claim 4, wherein the liquid flow path in the first half cell comprises a flow guide which is located adjacent to the electrode and comprises a spaced array of obstructions positioned to compel flow along the flow path to make changes of direction.

6. The battery system of claim 4, wherein the liquid flow path in the first half-cell extends through a porous material in which connected pores compel flow along the flow path to make a succession of changes of direction.

7. The battery system of claim 1, wherein the solute enabling the liquid to display elastic turbulence is a linear polymer with a molecular weight of at least 10⁶ Daltons.

8. The battery system of claim 1, wherein the solute enabling the liquid to display elastic turbulence is a viscoelastic surfactant which forms worm-like micelles in the liquid.

9. The battery system of claim 1, wherein the only solvent in the liquid is water.

10. The battery system of claim 1, wherein the solvent in the liquid is a mixture of water and a water-soluble organic compound

11. A method of operating the battery system of claim 1, comprising:
charging the half-cell by supply of electric current to the electrode while pumping the liquid through the half-cell and discharging the half-cell by taking electric current from the electrode while pumping the liquid through the half-cell, with the liquid being in a condition of elastic turbulence while it is in contact with the electrode in the half-cell and also while it is flowing through the bed in the vessel, both while charging and while discharging.

12. The method of claim 11, wherein the half-cell has a flow guide located adjacent to the electrode, the flow guide comprising a spaced array of obstructions positioned to compel flow to make changes of direction and wherein the viscosity of the liquid, the flow rate of the liquid within the flow guide and the width of the gaps between obstructions give a Reynolds number (Re) for the flow through the flow guides which is in a range from 1 to 250.

13. A flow battery comprising two battery systems, each according to claim 1 with their half-cells at opposite sides of a separator which prevents mixing of the liquids of the two systems but allows passage of selected ions.

14. The flow battery of claim 13, wherein the separator is an ion exchange membrane.

15. A method of operating the flow battery of claim 13, comprising charging the battery by supply of electric current to the electrodes while pumping the liquids of the two systems through their half-cells and discharging the battery by taking electric current from the electrode while pumping the liquids of the two systems through their half-cells, with both liquids being in a condition of elastic turbulence while in contact with the electrodes in the half-cells and also while flowing through the beds in the vessels, both while charging and while discharging.

16. The method of claim 15, wherein the half-cells both have a flow guide located adjacent to the electrode, the flow guides each comprising a spaced array of obstructions positioned to compel flow to make changes of direction and wherein the viscosities of the liquids, the flow rates of the liquids within the flow guides and the width of the gaps between obstructions give Reynolds numbers (Re) for the flows through the flow guides which are in a range from 1 to 250.
